(19) United States
(12) Patent Application Publication
(10) Pub. No.: US 2025/0147859 A1
(43) Pub. Date: May 8, 2025

(54) Inferred Events

(71) Applicant: CARDINALOPS LTD., Tel Aviv (IL)

(72) Inventors: Yair Manor, Netanya (IL); Alex Gelman, Netanya (IL); Amihai Hadar, Herzliya (IL)

(21) Appl. No.: 18/500,143

(22) Filed: Nov. 2, 2023

(51) Int. Cl. G06F 11/30; G06F 11/34

(52) U.S. Cl. CPC G06F 11/3072; G06F 11/3476

(57) ABSTRACT

In one embodiment, a device includes a processor configured to generate a query to search for at least one event type in log data, provide the query to a data service to run against the log data, receive from the data service a result of running the query against the log data, and infer information from the result about a given family of event-types, the given family of event-types including the at least one event type, and a memory configured to store data used by the processor.

### FIELD OF THE INVENTION

The present invention relates to computer systems, and in particular, but not exclusively, to data service systems.

### BACKGROUND

SIEM stands for Security Information and Event Management. It is a software platform that aggregates, analyzes, and stores data from various sources, including syslog servers. SIEMs refer to centralized log management tools that integrate with different applications, systems, servers, etc. to take in data from each service. SIEMs are used for real-time security event analysis to help with investigation, early threat detection and incident response.

SIEM servers work by gathering all the event logs from configured devices. The logs are sent to a collector, which typically runs on a virtual machine inside the host network. The logs are securely sent from the collector to the SIEM. In other cases, the logs can be sent directly to the SIEM server, or the logs can be sent to a storage location (e.g., an S3 bucket), from which the SIEM server pulls them periodically.

SIEM servers use rules that help security teams define threats and generate alerts. Simple SIEM rules detect an event type and trigger a response, while composite rules nest or join two or more rules or statements to achieve a more complex behavior. Common SIEM correlation rules include brute force detection, impossible travel, excessive file copying, distributed denial-of-service (DDoS) attack, and file integrity change.

### SUMMARY

There is provided in accordance with an embodiment of the present disclosure, a device, including a processor configured to generate a query to search for at least one event type in log data, provide the query to a data service to run against the log data, receive from the data service a result of running the query against the log data, and infer information from the result about a given family of event-types, the given family of event-types including the at least one event type, and a memory configured to store data used by the processor.

Further in accordance with an embodiment of the present disclosure the processor is configured to infer information from the result about a given event type in the given family of event-types, and the result of running the query against the log data does not include events of the given event type.

Still further in accordance with an embodiment of the present disclosure the processor is configured to infer that the data service is not configured to receive events of the given family of event types or a given event type in the given family of event types responsively to the result indicating zero hits from running the query to search for the at least one event type against the log data, and provide an alert indicating that the data service is not configured to receive the events of the given family of event types or a given event type in the given family of event types.

Additionally in accordance with an embodiment of the present disclosure the processor being configured to receive a given rule from the data service, the given rule being configured to search for events of a given event type, find the given family of event-types including the given event type, and generate the query to search for the at least one event type included in the given family of event-types in the log data.

Moreover, in accordance with an embodiment of the present disclosure the processor is configured to infer that the given family of event-types or the given event type is not relevant to an operating environment responsively to the result indicating zero hits from running the query against the log data, and provide an alert indicating that the given rule is irrelevant for the operating environment.

Further in accordance with an embodiment of the present disclosure the processor is configured to infer that the data service is configured to receive events of the given event type responsively to the result indicating non-zero hits from running the query against the log data.

Still further in accordance with an embodiment of the present disclosure the processor is configured to provide an alert indicating that the data service or at least one log data source is configured correctly to provide log data for the given rule.

Additionally in accordance with an embodiment of the present disclosure the data service is at least one of a rule-based detection service, a rule-based security service, or a security information and event management (SIEM) service.

Moreover, in accordance with an embodiment of the present disclosure the processor is configured to generate the query to search for events in a time window, the result of running the query against the log data including multiple events, identify event-types of the multiple events, and infer which families of event-types are in an operating environment from the identified event-types.

Further in accordance with an embodiment of the present disclosure the processor is configured to infer any one or more of the following from the families of event-types in the operating environment a configuration of log data sources feeding the data service, which services are being used, how the services are being used, which cloud-based services are being used, or which rules in the data service are redundant.

Still further in accordance with an embodiment of the present disclosure the processor is configured to identify log data sources of events in the given family of event-types, and provide an indication about a value of the inference or perform an action based on the identified log data sources.

There is also provided in accordance with another embodiment of the present disclosure, a method, including generating a query to search for at least one event type in log data, providing the query to a data service to run against the log data, receiving from the data service a result of running the query against the log data, and inferring information from the result about a given family of event-types, the given family of event-types including the at least one event type.

Additionally in accordance with an embodiment of the present disclosure the inferring includes inferring information from the result about a given event type in the given family of event-types, and the result of running the query against the log data does not include events of the given event type.

Moreover in accordance with an embodiment of the present disclosure the inferring includes inferring that the data service is not configured to receive events of the given family of event types or a given event type in the given family of event types responsively to the result indicating zero hits from running the query to search for the at least one event type against the log data, the method further including providing an alert indicating that the data service is not configured to receive the events of the given family of event types or a given event type in the given family of event types.

Further in accordance with an embodiment of the present disclosure, the method includes receiving a given rule from the data service, the given rule being configured to search for events of a given event type, and finding the given family of event-types including the given event type, wherein the generating includes generating the query to search for the at least one event type included in the given family of event-types in the log data.

Still further in accordance with an embodiment of the present disclosure the inferring includes inferring that the given family of event-types or the given event type is not relevant to an operating environment responsively to the result indicating zero hits from running the query against the log data, the method further including providing an alert indicating that the given rule is irrelevant for the operating environment.

Additionally in accordance with an embodiment of the present disclosure the inferring includes inferring that the data service is configured to receive events of the given event type responsively to the result indicating non-zero hits from running the query against the log data.

Moreover, in accordance with an embodiment of the present disclosure, the method includes providing an alert indicating that the data service or at least one log data source is configured correctly to provide log data for the given rule.

Further in accordance with an embodiment of the present disclosure the data service is at least one of a rule-based detection service, a rule-based security service, or a security information and event management (SIEM) service.

Still further in accordance with an embodiment of the present disclosure the generating includes generating the query to search for events in a time window, the result of running the query against the log data including multiple events, the method further includes identifying event-types of the multiple events, and the inferring includes inferring which families of event-types are in an operating environment from the identified event-types.

Additionally in accordance with an embodiment of the present disclosure the inferring includes inferring any one or more of the following from the families of event-types in the operating environment a configuration of log data sources feeding the data service, which services are being used, how the services are being used, which cloud-based services are being used, or which rules in the data service are redundant.

Moreover, in accordance with an embodiment of the present disclosure, the method includes identifying log data sources of events in the given family of event-types, and providing an indication about a value of the inference or performing an action based on the identified log data sources.

There is also provided in accordance with still another embodiment of the present disclosure, a software product, including a non-transient computer-readable medium in which program instructions are stored, which instructions, when read by a central processing unit (CPU), cause the CPU to generate a query to search for at least one event type in log data, provide the query to a data service to run against the log data, receive from the data service a result of running the query against the log data, and infer information from the result about a given family of event-types, the given family of event-types including the at least one event type.

### BRIEF DESCRIPTION OF THE DRAWINGS

The present invention will be understood from the following detailed description, taken in conjunction with the drawings in which:

FIG. 1 is a block diagram view of a data service inference system constructed and operative in accordance with an embodiment of the present invention;

FIG. 2 is a flowchart including steps in a method of operation of a device in the system of FIG. 1; and

FIGS. 3-6 are flowcharts including steps in sub-methods of the method of FIG. 2.

### DESCRIPTION OF EXAMPLE EMBODIMENTS

### Overview

There are several challenges that can arise with rule-based systems (e.g., security systems), such as SIEM servers running SIEM rules. Organizations may not have the resources or expertise to properly configure and manage their SIEM systems, which can lead to misconfigurations and redundant rules that are irrelevant to the operating environments of respective log data sources. Misconfigurations may lead to relevant logs not being forwarded to the SIEM system and may result in undetected events and associated security risks. Redundant rules may lead to wasting SIEM searching resources as the rules are not relevant to the operating environment(s) of the respective log data source(s). For example, some event types may be irrelevant to how the log data source is being used within the organization. For example, if AWS is used, but not S3, then no S3 events will be seen, and S3 rules may be irrelevant.

Therefore, embodiments of the present invention address at least some of the above drawbacks by searching event logs in a data service and inferring from the search results whether a rule is relevant or irrelevant to the operating environment(s) of the respective log data source(s), and/or whether the data service and/or log data sources are configured correctly. It should be noted that a user may need to configure the data logging as by default some logs may be disabled.

Events of an event-type family are typically generated by the same log data source. However, it should be noted that each log data source may provide a log of events of different event-types belonging to more than one event-type family. An event-type family may be a collection of events resulting from the application service.

In general, in order for an event type to be received in the SIEM, the following must all be true: (a) the data source (e.g., a Windows machine, AWS account, etc.) is configured to create the appropriate audit event when a certain “real world event” occurs; (b) the log forwarding infrastructure is configured to forward the audit event to the SIEM; (c) the SIEM is configured to process (i.e., not drop) the audit event; and (d) the event actually occurs. The policies for items (a), (b) and (c) above may be configured at the level of an event type family rather than individual events. Therefore, if the SIEM has a log of event of an event type family belonging to a specific event type family, it may be inferred with a high degree of confidence that other event types from this family will be seen in the SIEM after the appropriate event actually occurs.

Conversely, if no events belonging to a given event-type family are found by the data service, it may be inferred that the data service and/or the log data source is configured incorrectly or that the given event-type family is not relevant to the operating environment(s) of the respective data source(s) and that any rules searching for events in the given event-type family may be redundant. The systems administrator may be alerted that the data service and/or the log data source(s) are configured incorrectly, and/or that one or more rules are irrelevant.

In some embodiments, searching event logs in the data service and inferring from the search results whether the data service and/or log data sources are configured correctly for events of a given event-type family or families may be performed irrespective of rules and may even be performed in an environment where rules are not used or rules for the given event-type family do not currently exist. For example, event logs may be searched and reveal that AWS is being used and events of AWS are being logged and the logs provide visibility to AWS events. Conversely, the absence of events of a given event-type family may mean that the data service is “blind” to events of the given event-type family and has no log visibility to events of the given event-type family.

In some embodiments, the system may infer that a given event type (or an event-type family including the given event type) should be received by the data service (and that the data service and the log data source of the given event type are configured correctly) as an event or events of at least one other event type in the same family of event types as the given event type is being received by the data service. For example, a rule to detect deletion of an email account may rely on a given log configuration. The same log configuration may also include events related to the creation of an email account. Therefore, the system may infer that if an event related to creating an email account is found, events for account deletion would also be captured when they occur.

In some embodiments, the system may infer that a given event type (or the event-type family including the given event type) will not be received by the data service (and that the data service and/or the log data source of the given event type are configured incorrectly, or that the given event type is irrelevant to the operating environment(s) of the respective data source(s)) as no events of other event types in the same family of event types as the given event type are being received by the data service.

For example, if the given event type is a very common event-type expected to occur in many, if not, all operating environments, or if the given event type is expected to occur in this operating environment, then it may be inferred that the data service and/or the log data source(s) are configured incorrectly. If the given event type (or the event-type family including the given event type) is not a very common event-type, then it may be inferred that a rule or rules searching for the given event type (or any of the event types in the event-type family including the given event type) may be irrelevant. This may be confirmed based on another (e.g., broader) search. For example, if a rule fires when administrator privileges are granted to a user to use containers and we do not know if this event is rare in the operating environment(s) of the respective log data source(s), the system may search to find a broader class of events, to determine if there are any container events in the operating environment(s) of the respective log data source(s) and therefore confirm whether the event type is rare or whether the logs and/or the data service are not configured correctly.

In some embodiments, a rule is retrieved from the data service, and analyzed to determine for which event-type(s) the rule searches. The event-type family for the event-type(s) in the rule is found and a query is generated to search for any event-type in that event-type family. The query is submitted to the data service (e.g., SIEM service) and the data service runs the query against the data logs of the data service (for a given time window, e.g., 3 months) yielding a number of hits. If there are relevant hits, then the data service and the log data source are configured correctly to receive events in that event-type family and the rule is validated as potentially useful. If there are no hits, then the data service and/or the log data source may be incorrectly configured with respect to logs of that event-type family or events of that event-type family may be irrelevant to the operating environment(s) of the log data source(s), which may indicate that the rule is irrelevant and should be removed from the list of rules run by the data service.

In some embodiments, one or more queries are generated to search for important event-types. The queries are submitted to the data service, and the data service runs the queries against the data logs of the data service (for a given time window, e.g., 3 months) yielding a number of hits. The result may indicate whether the data service and the log data source are configured correctly to receive event logs for the important event types.

In some embodiments, a query is generated to search for all events (or the first event of each event type) for a given time window. The query is submitted to the data service and a list of all the events (or the first event of each event type) is provided by the data service. The list may then be analyzed to determine which event-type families are present in the list and thereby determine for which event-type families the data service and the log data source(s) are configured correctly and for which event-type families the data service and/or the log data source(s) are not configured correctly, or which event-type families are irrelevant to the operating environment(s) of the log data source(s).

In some embodiments, the source of events may be identified. For example, the monitored hosts or the accounts sourcing the events may be identified. The value of the inference may be determined based on the source of the events. For example, if the inference is based on events from a single test account, or a laboratory environment, or from a small subset of hosts, the value of the inference may be lower than if the inference is based on events from multiple test environments or from a production environment including a large number of hosts. The system may provide an indication about a value of the inference to the system administrator or perform an action based on the identified log data source. For example, the system may alert the system administrator that a rule is only useful for detecting events sourced from a minor source of events and consideration should be given to remove the rule from the data service or that the administrator should consider extending monitoring of these events to cover one or more additional sources. Alternatively, the system may remove the rule from the data service, based on the rule only being useful for detecting events sourced from a minor source of events. The system administrator may define what criteria should be used to determine if a source of events is to be considered minor.

Embodiments of the present invention improve the way a computer or other processing device works by providing better computer performance, providing higher processing speed, providing less latency, and reducing power consumption, by removing irrelevant rules. If event logging configuration is improved, more relevant events may be found thereby improving computer security.

### System Description

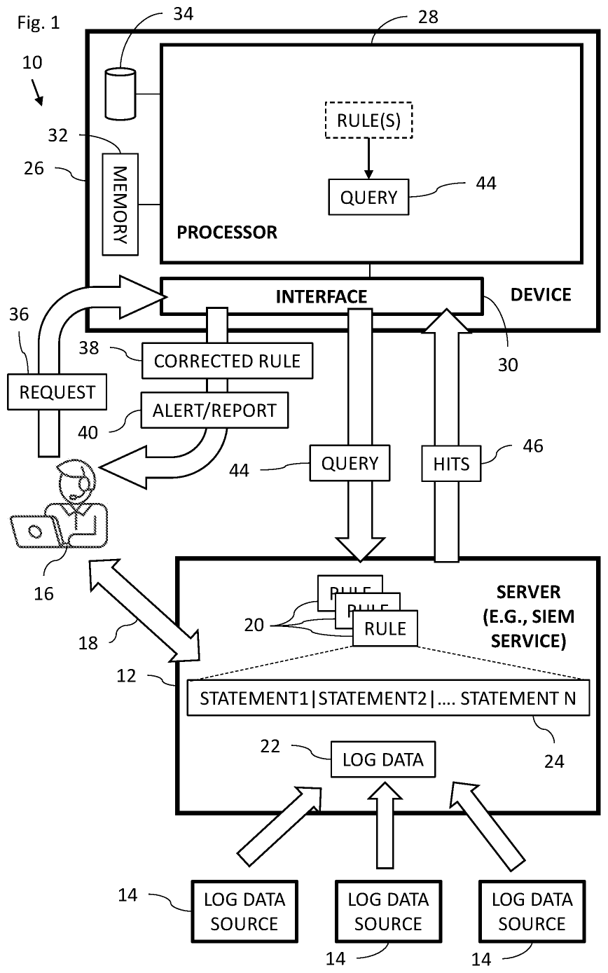

Reference is now made to FIG. 1, which is a block diagram view of a data service inference system 10 constructed and operative in accordance with an embodiment of the present invention. The data service inference system 10 includes a server 12 such as a security information and event management (SIEM) server or SIEM service or any suitable server or data service, or rule-based detection service which tracks events and reports on those events using rules (e.g., SIEM correlation rules or security rules), or a rule-based security service. The server 12 is configured to receive log data 22 from different log data sources 14 or from one or more collectors (not shown) which collect log data from the log data sources 14.

A system administrator 16 interacts (arrow 18) with the server 12 and configures rules 20 that should be run by the server 12 against the log data 22, for example, when the log data 22 is received from the log data sources 14. The server 12 may also generate an alert to the system administrator 16 when one of the rules provides a positive match with one or more events in the log data 22. Each rule 20 includes a respective number of statements 24 which define what the rule is checking for. The statements may be ordered in any suitable manner. However, in many cases, the statements are structured to start with the broadest statement and then progress to narrower statements so that the final statement is generally viewed as being the narrowest statement. The statements may be separated by any suitable symbol(s), for example, using a pipe symbol “|”. The server 12 may provide Application Programming Interfaces (APIs) to allow other entities (e.g., the system administrator 16 and a data service checking device 26) to interact with the server 12.

The data service inference system 10 also includes data service checking device 26, which includes a processor 28, interface 30, memory 32, and a database 34. The device 26 may receive requests 36 from the system administrator 16 to check one or more of the rules 20 to determine if the rule(s) is(are) are relevant in the operating environment(s) of the respective log data source(s) 14 and/or if the server 12 and the log data source(s) are correctly configured to receive the log data 22 from the log data sources 14. The device 26 may be configured to automatically check one or more of the rules 20 periodically.

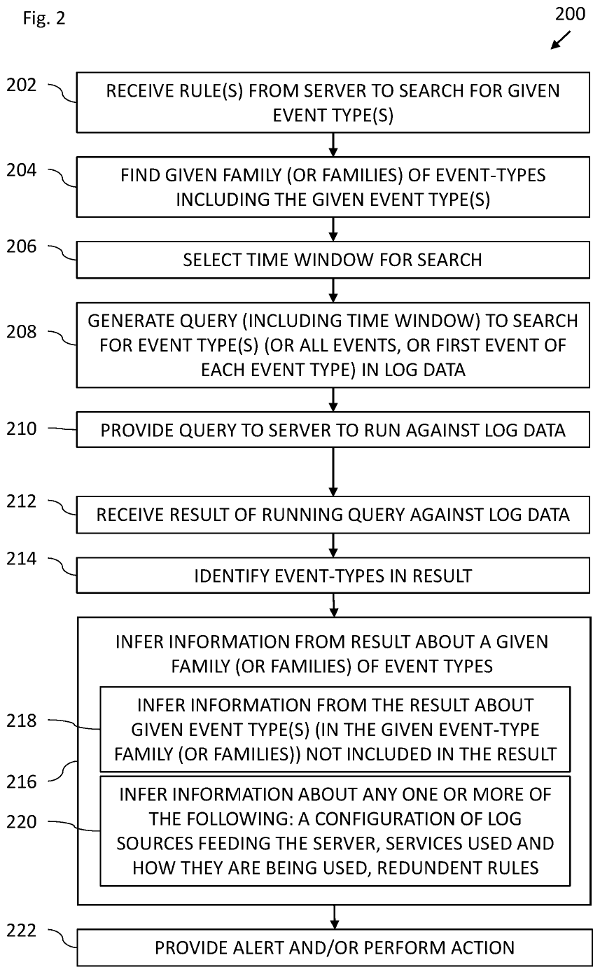

The interface 30 (which may include a network interface and/or a communication data bus interface) is configured to receive the requests 36 from the system administrator 16 and provide data (such as a corrected rule 38 (described in more detail below with reference to FIG. 2) and alerts or reports 40) to the system administrator 16. The interface 30 may also be configured to receive rules 20 and other data from the server 12 as well as provide queries 44 to the server 12, described in more detail below. The memory 32 is configured to store data used by the processor 28. The database 34 may be configured to store data such as event-type families and which event-types form part of which event-type families and the values (or importance) of different log data sources, described in more detail below.

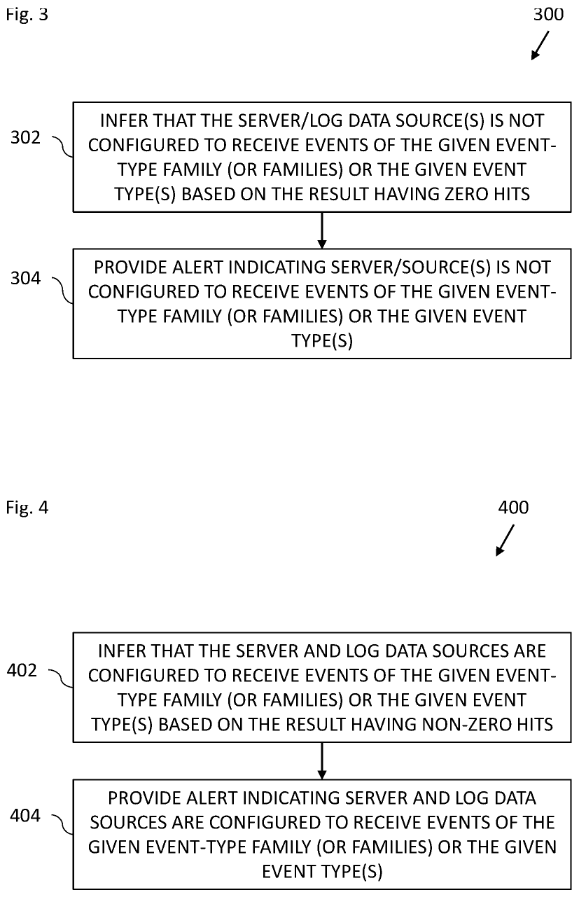

The processor 28 is configured to request data from the server 12 such as rules 20 and/or event-type data from the server 12, for example, in response to requests 36 from the system administrator 16, and generate queries 44 to determine if the rules 20 are relevant or irrelevant in the operating environment(s) of the respective log data source(s) 14 and/or determine if the server 12 and the log data source(s) are correctly configured to receive the log data 22 from log data sources 14. The processor 28 may be configured to request that the server 12 provide a given rule or rules to the processor 28 or provide a list of events (or important events, e.g., defined by the system administrator 16, or the first event of each event-type) in a given time window. The server 12 is configured to provide the given rule(s) to the processor 28, as requested. The processor 28 is configured to generate queries 44 from the data received from the server 12 as described in more detail with reference to FIG. 2. The processor 28 is configured to provide the queries 44 to the server 12 (either one by one or in batch) as described in more detail with reference to FIG. 2. The server 12 is configured to run the queries 44 against the log data 22 and provide to the processor 28 the respective number of hits 46 (and optionally a list of the events, or event-types, and/or sources of the events) resulting from running the queries 44 against the log data 22. Based on the number of hits 46 (and optionally the events found in the search), the processor 28 may determine if one or more rules are relevant or irrelevant to the operating environment and/or if the server 12 and the log data source(s) are correctly configured to receive the log data 22 from the log data sources 14, as described in more detail with reference to FIG. 1. The processor 28 may perform an action such as correcting a rule, and/or issuing an alert to the system administrator 16 about the correct or incorrect configuration of the server 12 and/or the log data source(s) to receive the log data 22 from the log data sources 14, and/or about whether a rule is irrelevant to the operating environment(s) of the respective log data source(s) 14, as described in more detail with reference to FIGS. 3-6.

In some embodiments, the functionality of the device 26 is executed by a cloud-based server. In some embodiments, the functionality of the server 12 is executed by a cloud-based server. In some embodiments, the functionality of the server 12 and the device 26 may be executed by the same device or server and/or the same processor.

In practice, some or all of the functions of the processor 28 may be combined in a single physical component or, alternatively, implemented using multiple physical components. These physical components may comprise hard-wired or programmable devices, or a combination of the two. In some embodiments, at least some of the functions of the processor 28 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 2, which is a flowchart 200 including steps in a method of operation of a device in the system 10 of FIG. 1. The processor 28 may be configured to receive, via the interface 30, requests 36 from the system administrator 16 to check one or more of the rules 20 and/or check that the server 12 and/or the log data source(s) are configured correctly to receive the log data 22 from the log data sources 14. The corrected rule 38 may be configured to receive, from the server 12 via the interface 30, one or more of the rules 20 (including a given rule 20), for example, responsively to receiving one or more requests 36 from the system administrator 16 (block 202). The given rule(s) may be configured to search for events of a given event-type or event-types. The processor 28 may be configured to find a given family of event-types (or given families of event-types) including the given event type(s), for example by looking up the given event-type(s) in a database of event-type families stored in the database 34 (block 204). The database of event-type families may be created by examining vendor documentation to determine how the event logs are configured or by examination of event logs from different servers. Event types may have prefixes which imply which event-type family the event types belong to. Additionally, or alternatively, the event-family types may be created based on any one or more of the following: “feature groups” within certain products that have specific functionalities that may be turned on or off; audit policies (most notably within Windows) where each setting affects the auditing of a group of operations; and services within cloud providers (e.g. AWS, GCP, Azure) where each service is in principle independent from the others.

The processor 28 may be configured to select a time window over which a query should run (block 206). The time window may be set to any suitable value, for example, one week, one month, three months, or one year. The time window may be dependent on the event-type family being investigated or the operating environment(s) of the log data source(s) 14. If the time window is too small, relevant events may be missed, and if the time window is too large, irrelevant events may be found as the logging configuration has changed due to changes in the operating environment(s). The time window may be determined at least partially by the system administrator 16. In some embodiments, the time window may be set to include events of any age.

The processor 28 is configured to generate a query to search in log data 22 for events of one or more event types in the selected time window (block 208). In some embodiments, the processor 28 is configured to generate the query to search in the log data 22 for events of any event-type (e.g., all event-types) in the given family (or families) of event-types, e.g., found in the step of block 204. In some embodiments, the query may be limited to find the first event in each event-type included in the query.

The processor 28 is configured to provide the query to the server 12 via the interface 30 to run against the log data 22 (block 210). The server 12 is configured to receive the query and run the query against log data 22 yielding a result and the result may include multiple values or a single value indicating the number of hits for example. The result may include any one or more of the following: a total number of hits against the log data 22; a list of the events found matching the query criteria; a list of event-types of the events found matching the query criteria; log data sources for each of the events, or a summary listing the number of hits by log data source (e.g., 2 hits from log data source A, 5 hits from log data source B etc.). The server 12 is configured to provide the result to the processor 28 of the device 26 via the interface 30.

The processor 28 is configured to receive from the server 12 the result of running the query against the log data 22 (block 212). If the query searched for multiple event-type families, then the processor 28 may be configured to identify event-types of the multiple events included in the result and perform a lookup of the database of event-type families stored in the database 34 to identify the event-type families included in the result (block 214).

The processor 28 is configured to infer information from the result about a given event-type family (or families) (based on the event-types of the events included in the result), or a given event type in the given family of event-types, or about given event-types in the given family (or families) of event-types (block 216). The terms “event-type family” or “family of event-types”, in all grammatical forms, have the same meaning. In some embodiments, the processor 28 is configured to infer information from the result about given event-type(s) in the given family (or families) of event-types that are not included in the result (block 218). For example, if the result indicates or includes one or more events of at least one event type (but does not include events of the given event type) in the given family of event-types, then it may be inferred that the server 12 and log data source(s) are also configured correctly to receive events of the given event type which is also in the given family of event-types. If the result indicates zero hits for events of the given family of event-types then it may be inferred that the server 12 (and/or the log data source(s)) are either not configured correctly to receive events of the given family of event-types or that events of the given family of event-types are irrelevant to the operating environment(s) of the respective log data source(s) 14, as described in more detail with reference to FIGS. 3-5.

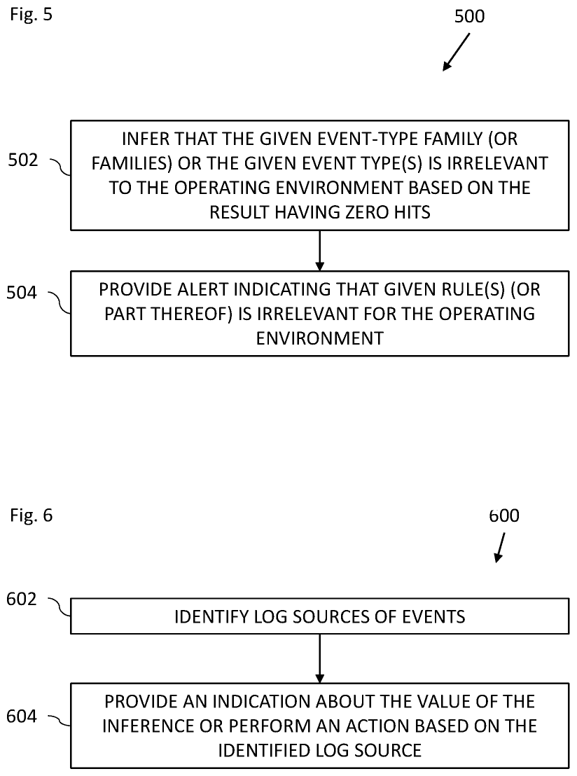

The processor 28 may be configured to infer which families of event-types (based on the event-types of the events included in the result) are in an operating environment(s) of the respective log data source(s) 14 from the identified event-types (identified in the step of block 214). The processor 28 may be configured to infer any one or more of the following from the families of event-types in the operating environment of the respective log data source(s) 14: a configuration of log data sources feeding the server 12; which services or functionality are being used and how they are being used; or which rules in the server 12 are redundant, as described in more detail with reference to FIG. 5. The services or functionality may include could-based services (e.g., which specific AWS services are being used) or modules within a product (e.g., firewall modules).

The processor 28 may be configured to provide an alert to the system administrator 16 (as described in more detail with reference to FIGS. 3-6), or correct a rule (e.g., to remove event-types which are not relevant to the operating environment(s) of the log data source(s) 14).

The steps of blocks 202-222 may be performed in any suitable order, with one or more of the steps being skipped. In some embodiments, the steps of blocks 202-222 may be performed as follows. The processor 28 is configured to select the time window (block 206), generate the query to search in log data 22 for events of all event-types (or event-types considered to be important to the operating environments, for example, as defined by the system administrator 16) in a time window (block 208). The query is provided to the server 12 (block 210), which processes the query against the log data 22 for the selected time window. Once the query is processed by the server 12, the server 12 sends the result to the processor 28. The processor 28 receives the result (block 212). The result of running the query against the log data 22 includes multiple events (and optionally the corresponding log data sources of the events). The processor 28 is configured to analyze the events included in the query result to find the event-type families of the events in the result based on looking up the event-types in the database of event-type families stored in the database 34 (block 214). The processor 28 is configured to infer from the result about the event-type families that are found and/or not found in the log data 22 (block 216). The processor 28 may also infer from the event-type families that are not found in the log data 22 that the server 12 and/or the log data source(s) are not configured correctly to receive events for the families not found in the log data 22 or infer that the rules including event-types of the families not found in the log data 22 maybe irrelevant to the operating environment(s) of the respective log data source(s) 14. The processor 28 may also find the rules including event-types of the families not found in the log data 22 by searching the rules for the relevant event-types. The processor 28 is configured to provide an alert to the system administrator 16 based on the inferred information as described above with reference to steps 216-220 above. For example, the processor 28 may alert the system administrator 16 to check the configuration of the server 12 for receiving the log data 22 for the event-type families not found in the log data 22 and/or remove/correct rules associated with the event-type families not found in the log data 22. In some embodiments, the processor 28 may correct the rule(s) including event-types of the families not found in the log data 22 to remove the event-types of the families not found in the log data 22 from the rule(s).

Reference is now made to FIG. 3, which is a flowchart 300 including steps in a sub-method of the method of FIG. 2. The processor 28 is configured to infer that the server 12 is not configured to receive events of the given family (or families) of event types or a given event type (or types) in the given family (or families) of event types responsively to the result of the query indicating zero hits from running the query to search for one or more event types (e.g., all event types) (in the given family (or families) of event types) against the log data 22 (block 302). The processor 28 is configured to provide an alert (e.g., to the system administrator 16) indicating that the server 12 is not configured to receive the events of the given family (or families) of event types or a given event type (or types) in the given family (or families) of event types (block 304) based on the step of block 302.

Reference is now made to FIG. 4, which is a flowchart 400 including steps in a sub-method of the method of FIG. 2. The processor 28 is configured to infer that the server 12 is configured to receive events of the given event type(s) or events of the given event-type family or families responsively to the result indicating non-zero hits from running the query against the log data (block 402) for the respective event-type family. For example, if there are non-zero hits for events of event-type family A, but zero hits for events of event-type family B, then it may be inferred that the server 12 and the log data source are correctly configured to receive events of event-type family A but not for event-type family B.

The processor 28 processor is configured to provide an alert (e.g., to the system administrator 16) indicating that the server 12 and the log data source(s) are configured correctly to provide log data for the given rule (block 404) or at least part of the given rule, as applicable.

Reference is now made to FIG. 5, which is a flowchart 500 including steps in a sub-method of the method of FIG. 2. The processor 28 may be configured to infer that the given family (or families) of event-types or the given event type(s) is not relevant to an operating environment(s) of the respective log data source(s) 14 responsively to the result indicating zero hits from running the query against the log data 22 (block 502).

The processor 28 may infer that a given event type (or the event-type family including the given event type) will not be received by the server 12 (and that the server 12 and/or the log data source of the given event type is configured incorrectly, or that the given event type is irrelevant to the operating environment(s) of the respective log data source(s) 14) as no other event types in the same family of event types as the given event type are being received by the server 12. For example, if the given event type is a very common event-type expected to occur in many, if not, all operating environments, or if the given event type is expected to occur in the operating environment of the respective log data source(s) 14, then it may be inferred that the server 12 and/or the log data source(s) is configured incorrectly. If the given event type (or the event-type family including the given event type) is not a very common event-type, then it may be inferred that a rule or rules searching for the given event type (or any of the event types in the event-type family including the given event type) may be irrelevant. This may be confirmed based on another (e.g., broader) search. For example, if a rule fires when administrator privileges are granted to a user to use containers and we do not know if this event is rare in the operating environment(s) of the respective log data source(s) 14, the processor 28 may request the server 12 to search to find a broader class of events, to determine if there are any container events in the operating environment(s) of the respective log data source(s) 14 and therefore confirm whether the event type is rare or whether the server 12 and/or the log data source(s) are not configured correctly.

Based on determining that the rule or rules are irrelevant to the operating environment(s) of the respective log data source(s) 14, the processor 28 is configured to provide an alert (e.g., to the system administrator 16) indicating that the given rule is irrelevant for the operating environment(s) of the respective log data source(s) 14 (block 504). Additionally, or alternatively, the processor 28 may be configured to correct the rule(s) including the “irrelevant” event-type(s).

Reference is now made to FIG. 6, which is a flowchart 600 including steps in a sub-method of the method of FIG. 2. The processor 28 may be configured to identify log data sources of events in the given family of event-types from the result of the query (block 602). The log data sources of the events may be listed in the result of the query. The processor 28 may be configured to provide an indication about the value of the inference made from the result (e.g., in an alert regarding configuration or whether to remove or amend a rule) or perform an action (e.g., remove or amend a rule) based on the identified log data source (block 604).

For example, the monitored hosts or the accounts sourcing the events may be identified. A value of the inference may be determined based on the source or source type of the events and/or a number of log data sources for the event-type or event-type family. For example, if the inference is based on events from a single test account, or a laboratory environment, or from a small subset of hosts, the value may be lower than if the inference is based on events from multiple test environments or from a production environment including a large number of hosts. The processor 28 may provide an indication about a value of the inference to the system administrator 16 or perform an action based on the identified log data source. For example, the processor 28 may alert the system administrator 16 that a rule is only useful for detecting events sourced from a minor source of events and consideration should be given to remove the rule from the server 12 or extend the logging configuration to include additional hosts, for example. Alternatively, the processor 28 may remove the rule from the server 12, based on the rule only being useful for detecting events sourced from a minor source of events. The system administrator may define what criteria should be used to determine if a source of events is to be considered minor etc. For example, each type of event source may be assigned a value so that a list of events from different sources will be scored based on the values of the underlying sources. A threshold may define whether a score of events is considered a minor source of events or a major source of events. In some embodiments, other scoring methods may be used and/or different levels of thresholds may be used.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A device, comprising:
a processor configured to:
generate a query to search for at least one event type in log data;
provide the query to a data service to run against the log data;
receive from the data service a result of running the query against the log data; and
infer information from the result about a given family of event-types, the given family of event-types including the at least one event type; and
a memory configured to store data used by the processor.

2. The device according to claim 1, wherein:
the processor is configured to infer information from the result about a given event type in the given family of event-types; and
the result of running the query against the log data does not include events of the given event type.

3. The device according to claim 1, wherein the processor is configured to:
infer that the data service is not configured to receive events of the given family of event types or a given event type in the given family of event types responsively to the result indicating zero hits from running the query to search for the at least one event type against the log data; and
provide an alert indicating that the data service is not configured to receive the events of the given family of event types or a given event type in the given family of event types.

4. The device according to claim 1, wherein the processor being configured to:
receive a given rule from the data service, the given rule being configured to search for events of a given event type;
find the given family of event-types including the given event type; and
generate the query to search for the at least one event type included in the given family of event-types in the log data.

5. The device according to claim 4, wherein the processor is configured to:
infer that the given family of event-types or the given event type is not relevant to an operating environment responsively to the result indicating zero hits from running the query against the log data; and
provide an alert indicating that the given rule is irrelevant to the operating environment.

6. The device according to claim 4, wherein the processor is configured to infer that the data service is configured to receive events of the given event type responsively to the result indicating non-zero hits from running the query against the log data.

7. The device according to claim 6, wherein the processor is configured to provide an alert indicating that the data service or at least one log data source is configured correctly to provide log data for the given rule.

8. The device according to claim 4, wherein the data service is at least one of: a rule-based detection service; a rule-based security service; or a security information and event management (SIEM) service.

9. The device according to claim 1, wherein the processor is configured to:
generate the query to search for events in a time window, the result of running the query against the log data including multiple events;
identify event-types of the multiple events; and
infer which families of event-types are in an operating environment from the identified event-types.

10. The device according to claim 1, wherein the processor is configured to infer any one or more of the following from the families of event-types in the operating environment:
a configuration of log data sources feeding the data service;
which services are being used;
how the services are being used;
which cloud-based services are being used; or
which rules in the data service are redundant.

11. The device according to claim 1, wherein the processor is configured to:
identify log data sources of events in the given family of event-types; and
provide an indication about a value of the inference or perform an action based on the identified log data sources.

12. A method, comprising:
generating a query to search for at least one event type in log data;
providing the query to a data service to run against the log data;
receiving from the data service a result of running the query against the log data; and
inferring information from the result about a given family of event-types, the given family of event-types including the at least one event type.

13. The method according to claim 12, wherein:
the inferring includes inferring information from the result about a given event type in the given family of event-types; and
the result of running the query against the log data does not include events of the given event type.

14. The method according to claim 12, wherein the inferring includes inferring that the data service is not configured to receive events of the given family of event types or a given event type in the given family of event types responsively to the result indicating zero hits from running the query to search for the at least one event type against the log data, the method further comprising providing an alert indicating that the data service is not configured to receive the events of the given family of event types or a given event type in the given family of event types.

15. The method according to claim 12, further comprising:
receiving a given rule from the data service, the given rule being configured to search for events of a given event type; and
finding the given family of event-types including the given event type, wherein the generating includes generating the query to search for the at least one event type included in the given family of event-types in the log data.

16. The method according to claim 15, wherein the inferring includes inferring that the given family of event-types or the given event type is not relevant to an operating environment responsively to the result indicating zero hits from running the query against the log data, the method further comprising providing an alert indicating that the given rule is irrelevant for the operating environment.

17. The method according to claim 15, wherein the inferring includes inferring that the data service is configured to receive events of the given event type responsively to the result indicating non-zero hits from running the query against the log data.

18. The method according to claim 17, further comprising providing an alert indicating that the data service or at least one log data source is configured correctly to provide log data for the given rule.

19. The method according to claim 15, wherein the data service is at least one of: a rule-based detection service; a rule-based security service; or a security information and event management (SIEM) service.

20. The method according to claim 12, wherein:
the generating includes generating the query to search for events in a time window, the result of running the query against the log data including multiple events;
the method further comprises identifying event-types of the multiple events; and
the inferring includes inferring which families of event-types are in an operating environment from the identified event-types.

21. The method according to claim 20, wherein the inferring includes inferring any one or more of the following from the families of event-types in the operating environment:
a configuration of log data sources feeding the data service;
which services are being used;
how the services are being used;
which cloud-based services are being used; or
which rules in the data service are redundant.

22. The method according to claim 12, further comprising:
identifying log data sources of events in the given family of event-types; and
providing an indication about a value of the inference or performing an action based on the identified log data sources.

23. A software product, comprising a non-transient computer-readable medium in which program instructions are stored, which instructions, when read by a central processing unit (CPU), cause the CPU to:
generate a query to search for at least one event type in log data;
provide the query to a data service to run against the log data;
receive from the data service a result of running the query against the log data; and
infer information from the result about a given family of event-types, the given family of event-types including the at least one event type.
